(19) United States
(12) Patent Application Publication
(10) Pub. No.: US 2014/0100938 A1
(43) Pub. Date: Apr. 10, 2014

(54) LOCATION BASED AFFINITY PROGRAM

(71) Applicant: Philippe Caland, Los Angeles, CA (US)

(72) Inventor: Philippe Caland, Los Angeles, CA (US)

(21) Appl. No.: 14/048,736

(22) Filed: Oct. 8, 2013

Related U.S. Application Data
(60) Provisional application No. 61/711,946, filed on Oct. 10, 2012.

(51) Int. Cl. G06Q 30/02

(52) U.S. Cl. CPC G06Q 30/0231
USPC 705/14.31

(57) ABSTRACT

Aspects herein describe methods, systems, and apparatuses to provide and administer an affinity/loyalty program that credits affinity points to users based on where each user purchases a particular item (e.g., goods and services). The system may determine the amount of affinity points to award by comparing the geographic location of manufacture of the item purchased by the user with the geographic location where the user purchased the item. The user may be awarded more points the closer the location of purchase is to the location of manufacture. For example, the user may be awarded three points if the location of purchase is within the same city as the location of manufacture. On the other hand, the user may only be awarded two points if the location of purchase is within the same state (but not within the same city) as the location of manufacture.

### CROSS-REFERENCE TO RELATED APPLICATIONS

This application claims priority to U.S. Provisional Application No. 61/711,946, filed Oct. 10, 2012, the entire disclosure of which is hereby incorporated by reference in its entirety.

### FIELD

Aspects relate generally to computers, software, and networking. More specifically, aspects described herein provide methods, systems, apparatuses, and techniques for administering an affinity/loyalty program based on a location of manufacture of goods and/or services as compared to the location of purchase and/or consumption.

### BACKGROUND

As a global society, we are on a path that is very destructive and that has some chronic sociological diseases, such as excessive consumption, at the expense of the next generation. We are depleting the planet for our own indulgences, without much thought regarding how and why we consume resources. There is a realization that there can be a smart industrial complex which is far more sensitive to the needs of the next generations. There can be a planet that we can hand to future generations.

### SUMMARY

The following presents a simplified summary of various aspects described herein.

This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards a system, an apparatus, and/or computer readable media configured to perform a method comprising comparing, by a computing device, a geographic location of manufacture of an item purchased by a user with a geographic location where the user purchased the item and determining an amount of affinity points based on the comparison. The method may further comprise crediting the determined amount of affinity points to a user account stored in an affinity points database system. In some aspects, the amount of affinity points may comprise a first value if the geographic location of manufacture of the item is within a predetermined distance from the geographic location where the user purchased the item and/or a second value less than the first value if the geographic location of manufacture of the item is greater than a predetermined distance from the geographic location where the user purchased the item.

In some alternative aspects, the amount of affinity points may comprise a first value if the geographic location of manufacture of the item is within the same city as the geographic location where the user purchased the item. The amount of affinity points may comprise a second value less than the first value if the geographic location of manufacture of the item is not within the same city as the geographic location where the user purchased the item. The amount of affinity points may comprise a third value less than the second value if the geographic location of manufacture of the item is not within the same state as the geographic location where the user purchased the item. Furthermore, the amount of affinity points may comprise a fourth value less than the third value if the geographic location of manufacture of the item is not within the same country as the geographic location where the user purchased the item.

In some embodiments, determining the amount of affinity points may comprise (1) awarding a first predetermined amount of affinity points if the geographic location of manufacture of the item and the geographic location where the user purchased the item are within the same country, (2) awarding an additional second predetermined amount of affinity points if the geographic location of manufacture of the item and the geographic location where the user purchased the item are within the same state, and/or (3) awarding an additional third predetermined amount of affinity points if the geographic location of manufacture of the item and the geographic location where the user purchased the item are within the same city.

The method may further comprise receiving a request to redeem a reward and in response to the request, deducting, from the user account, an amount of affinity points corresponding to the reward. The reward may comprise at least one of a monetary amount, a physical good, a voucher for a service, and an entrance to a restricted facility. In some aspects, the method may also include receiving a request to transfer a first amount of affinity points to an organization, and in response to the request, deducting the first amount of affinity points from the user account and transferring the first amount to an account associated with the organization and stored in the affinity points database system.

In the method, determining the amount of affinity points based on the comparison may comprise determining that the purchase of the item qualifies for bonus points, and in response to determining that the purchase of the item qualifies for bonus points, crediting the bonus points to the user account. Furthermore, determining that the purchase of the item qualifies for bonus points may comprise determining that a disaster occurred at the geographic location of manufacture of the item.

Additional aspects described herein are directed towards a system, an apparatus, and/or computer readable media configured to perform a method comprising comparing a geographic location of manufacture of an item purchased by a user with a geographic location where the user purchased the item. A computing device may be used to determine whether a type of the purchase made by the user is a foreign purchase, a domestic purchase, an in-state purchase, or a local purchase based on the comparison. The method may further comprise crediting, to a user account stored in an affinity points database system, an amount of affinity points corresponding to the determined type of purchase. In some aspects, the amount of affinity points for a domestic purchase may be greater than the amount of affinity points for a foreign purchase, the amount of affinity points for an in-state purchase may be greater than the amount of affinity points for a domestic purchase, and/or the amount of affinity points for a local purchase may be greater than the amount of affinity points for an in-state purchase.

These and additional aspects will be appreciated with the benefit of the disclosures discussed in further detail below.

### BRIEF DESCRIPTION OF THE DRAWINGS

A more complete understanding of the present features and the advantages thereof may be acquired by referring to the following description in consideration of the accompanying drawings, in which like reference numbers indicate like features, and wherein:

FIG. 1 illustrates a system architecture that may be used according to one or more illustrative aspects described herein.

FIG. 2 illustrates a method for administering an affinity points program according to one or more illustrative aspects described herein.

### DETAILED DESCRIPTION

In the following description of the various embodiments, reference is made to the accompanying drawings, which form a part hereof, and in which is shown by way of illustration various embodiments described herein. It is to be understood that other embodiments may be utilized and structural and functional modifications may be made without departing from the scope of the present features described herein. Aspects are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As a general introduction, aspects herein describe methods, systems, and apparatuses to provide and administer an affinity/loyalty program where rewards are based on a location of manufacture of the purchased goods/services, as compared to the location in which the goods/services are purchased and/or consumed. For example, if a consumer were shopping in a grocery store in Brooklyn, N.Y., each product might be coded based on whether it was manufactured within Brooklyn, within the state of New York, within the United States of America, or foreign. The consumer might be awarded one affinity point for purchase of a foreign-made good, two points for an item made in the USA, three points for an item made in the same state (i.e., New York state, in this example), or four points for an item made within the same city or locality. Further details, options, and alternatives are provided below.

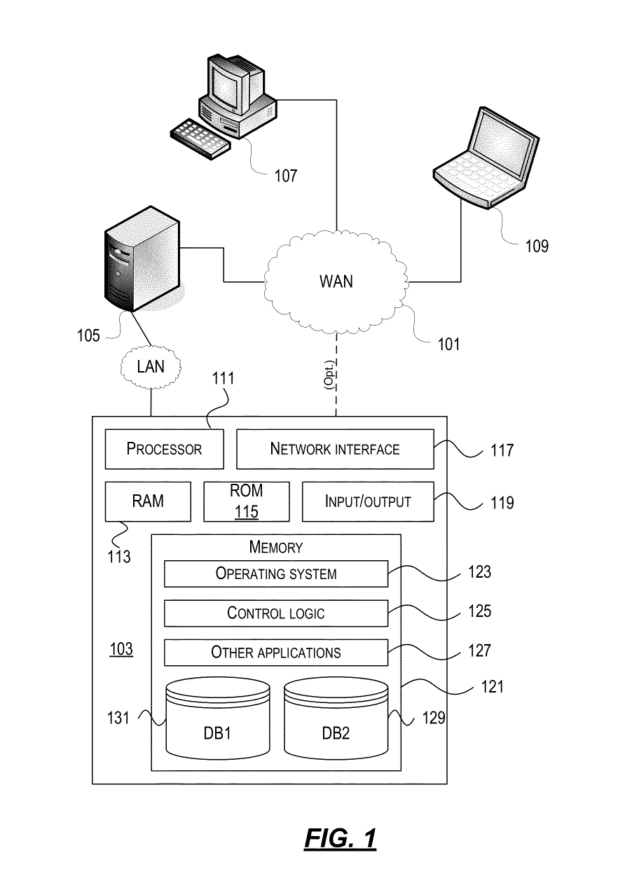

FIG. 1 illustrates one example of a network architecture and data processing device that may be used to implement one or more illustrative aspects of the features described herein. Various network nodes 103, 105, 107, and 109 (which may comprise computing devices) may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects of the features described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the rate server 103. Data server 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects of the features described herein, and other application software 127 providing secondary, support, and/or other functionality which may or may not be used in conjunction with aspects of the present features described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the features described herein, including a first database 129 and a second database 131. According to an illustrative aspect, database 129 may be or include a product database storing information regarding a location of manufacture of each product. For example, database 129 might store a product ID, a product description, SKU code or other sales code, and a location of manufacture for that product. Database 131 may be or include a user database storing affinity account information for various users. For example, database 131 might store user ID, user name, user email, user preferences, and an amount of affinity points associated with that user. Database 129 and/or 131 might further include a transaction table identifying each transaction resulting in an increase or decrease in affinity points for a user, e.g., as a result of purchasing an item or spending points to obtain a reward.

In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects of the features described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the features described herein, and such data structures are contemplated within the scope of computer executable instructions and computer-usable data described herein.

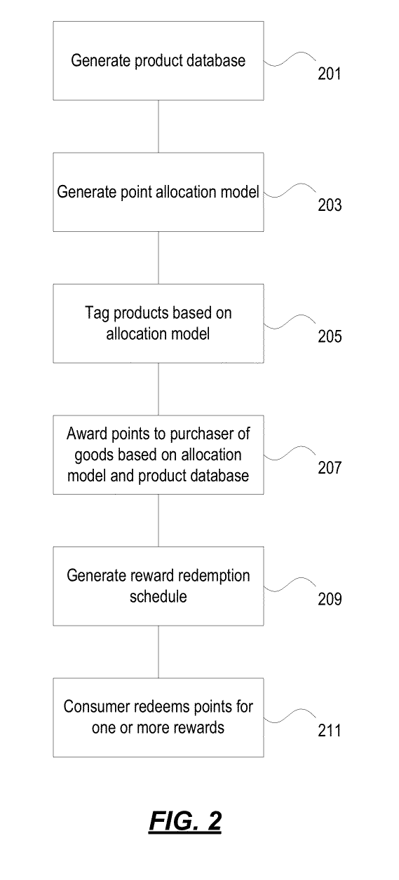

FIG. 2 illustrates a method of awarding affinity points according to one or more illustrative aspects. Initially, in step 201, an affinity program administrator (APA) populates database 129 with product manufacturing information, identifying at least a product code and a location of manufacture. As used herein, products may include services as well as tangible items, and a location of manufacture may be any geographic location associated with the product's origin in some meaningful way, such as the location in which the product is actually made, the country of origin, etc. Services may be associated with a location from which the service is actually performed. For example, if a bookkeeping service is actually performed by a foreign worker residing in India, then the service would be considered to be performed in India. However, if the same service is performed by a person in Gary, Indiana, then Gary, Indiana, would be used as the associated location.

In step 203, APA creates or designates an affinity points allocation model. According to one embodiment, one point may be awarded as a minimum reward per purchase, e.g., when a consumer purchases a product made outside of the country in which the product is purchased. An additional point may be awarded when a consumer purchases a product made in the same country as the location of purchase. Another additional point may be awarded when a consumer purchases a product made in the same state as the location of purchase. Still another additional point may be awarded when a consumer purchases a product made in the same city as the location of purchase, or when the consumer purchases a product made within a predetermined distance as the location of purchase. The above illustrative point allocation model may be summarized as: Foreign purchases=1 point each; domestic purchases=2 points each; in-state purchases=3 points each; local purchases=4 points each. Different point allocation models may alternatively be used.

Each category of purchases (e.g., foreign purchases, domestic purchases, in-state purchases, and local purchases) may further be divided into sub-categories with different numbers of affinity points awarded for each sub-category. For example, foreign purchases may be divided into purchases of products made in preferred countries and products made in non-preferred countries. More points may be awarded to purchases made from preferred countries (e.g., 1.5 points) than from purchases made from non-preferred countries (e.g., 1 point). Numerous factors may be used to categorize countries as preferred or non-preferred, such as payment of a living wage, labor laws (e.g., minimum wage, age requirements, hours per day worked, etc.), and workplace safety laws and standards in that country. For example, a foreign country may be preferred if it has a workers' compensation system, whereas another foreign country may be non-preferred if it does not have a workers' compensation system. As another example, a foreign country may be preferred if the minimum wage established by law is greater than the living wage, whereas another foreign country may be non-preferred if the minimum wage is less than the living wage for that country (or a region in that county). While the previous examples describe two sub-categories (preferred and non-preferred), one of ordinary skill in the art will recognize that any number of sub-categories (e.g., 3, 4, etc.) may be used to divide each purchase category.

In step 205, the APA may optionally tag or code the products themselves, so that consumers can easily identify where each product was manufactured, and thereby easily determine which products, if purchased, result in more points being awarded. According to a first embodiment, the APA may rely on a location of manufacture as imprinted by the manufacturer, or as required by any laws applicable to that product. According to another embodiment, the APA may provide additional tagging or coding to make it easier for consumers to identify locally made products. For example, the APA may cause foreign-made products to be marked with a yellow dot; products made in the USA to be marked with a blue dot; products made in a same state as store or location where they are sold may be marked with a light green dot; and products made in the same city or within a predetermined distance of the store or location where they are sold may be marked with a dark green dot (or alternatively, with two green dots). Other identification schemes may be used, and more or fewer than four levels of geographic proximity may be used. Because affinity points for a product may change based on the location of sale, a local seller may perform some or all of the tagging.

In step 207, a consumer purchases one or more items at a store or other location or virtually, such as from a website. The consumer may search for stores based on geographical location. For example, a consumer may enter his or her zip code (or other geographical indicator) into a search engine for the stores, and results for stores in or near the entered zip code may be returned. During the purchase transaction, the sales device, e.g., a cash register 109 or other point of sale terminal, communicates with database 129 to identify where each purchased product was manufactured, and calculates a resultant amount of points based on the comparison, using the point allocation model designated by the APA or other appropriate individual. Alternatively, the sales device 109 may transmit a list of product purchases to an affinity server device, e.g., device 103, to perform the computation. Device 103 may then send back to sales device 109 the total number of points earned during the transaction and modify database 131 with the consumer's updated affinity point information.

In step 209, the APA may create or designate an affinity point reward schedule. The reward schedule may be local to the store in which products were purchased, or may be citywide, statewide, national, or international in scope. The APA may coordinate with associate APAs, e.g., within a sub-region or portion of a geographic area for which the APA is responsible. According to one embodiment, rewards may include a monetary amount (e.g., cash, credit for purchases at a store, etc.), physical goods (e.g., consumer goods), vouchers for services (e.g., free move tickets, restaurants, etc.), entrance to one or more otherwise restricted facilities (e.g., to an affinity center owned or operated by the affinity program provider, offering a lounge, nightclub, restaurant, recreational facilities, meeting space, etc.). The point cost of a reward may vary based on the value of the reward.

In step 211, the consumer may decide to redeem one or more affinity points for a desired reward. The consumer may log on to a web site administered by the APA or affinity program provider, and select and “purchase” a desired reward using a known shopping cart model, based on a number of points accrued. Alternatively, each consumer may have a loyalty card or affinity ID number, and the consumer can redeem his or her points on location wherever an affinity reward may be used. For example, a consumer may present his or her affinity ID or other credentials at a restaurant, and the restaurant may redeem a reward on the consumer's behalf via a separate relationship between the restaurant and the affinity program provider. As another example, the consumer may present his or her affinity credentials at an affinity center operated by or associated with the affinity program provider, and the affinity center may automatically deduct points from the consumer's account in exchange for admission to or use of some services at the affinity center.

The above-described method is illustrative only, and modifications may be made without departing from the scope described. For example, steps may be added, rearranged, combined, split, or may be optional.

Variations of the above model may be made to provide additional incentives to consumers and to affect consumer behavior. In one illustrative alternative, products manufactured in a specific location may be associated with bonus points to encourage consumers to purchase products from that location. For special products, the APA may replace the number of points assigned to purchases of these products based on geographic location with a predetermined number of points assigned to special products. For example, if an event (e.g., a severe drought, fire, flood, or other disaster) affected a specific city or region, then products made in that city or region might earn 4 points per purchase, regardless of the location of purchase. These products might be tagged with a green dot with a star on it, to highlight to consumers that a high level of reward points may be earned even though the product might not be local. The dot with a star further indicates that the product is a special product, and that purchase of the product supports a region that might otherwise be facing economic woes. Other tagging identifiers may alternatively be used.

Using the above described method and systems, one can promote change in consumer behavior in a creative way that engages people's interest. Things economical thereby start to take into consideration all things environmental, and things ecological take into consideration all things economical. In this creative economy, consumers and merchants may take what the Earth gives to them and supplement these gifts with their own creativity, as opposed to double-dipping in the Earth's resources due to lack of creativity. Accordingly, aspects described herein may encourage micro economies, neighborhood economies and community economies, which may be more sustainable than large-scale economies. In these micro economies, it may be easier for local forces for sustainability to create models and have an impact on policies.

According to another aspect, an APA or affinity program provider may be associated with one or more retail centers (e.g., malls) that also act as community centers which simultaneously support philanthropies. These centers may be designed to be smart “eco-malls” built around a cool and comfortable modern hang-out space, including an atrium with free Wi-Fi and bordered by retail shopping at aligned company stores, restaurants and live entertainment. Major retailers may include high-end mall vendors who choose to participate as affiliates of and operate under guidelines of the location based affinity program. The retail center may include new businesses striving to fulfill the goal of sustainable, minimal-impact enterprises with an objective to better the world. Certain sections of the retail center may be devoted to businesses that sell things made locally first and within the state second. The retail center may also include a gym.

Each center may include multiple philanthropy kiosks plus a meeting space/community action center that can also host live volunteer events. People can exchange ideas sign up to volunteer in a way that is easy and comfortable. The atrium for hanging out may include comfortable seating for work, having a coffee or chatting; and a stage for lectures and live music.

There may also be a lounge which may be an anchor attraction for each center. In one embodiment, the lounge may overlook a park and be a high-quality sustainable food restaurant. Typical of similar anchor establishments, the lounge may generate sufficient revenue to underwrite the cost of center's operations.

With each purchase at the center's shops and venues, a percentage of each purchase may be donated back to philanthropies. The consumer may be able to select a philanthropy or non-profit from a menu and then choose whether to give either all the affinity points that might have otherwise been earned to that organization, or only half the points and use the other half in accordance with the reward redemption schedule. Customers may also have an option to save the points and pool them with others toward larger rewards, e.g., building community enterprises such as a community theater or a new park.

When people sign up as volunteers with any of the featured non-profits in the mall, the philanthropy will keep them informed of the amount of their service and they may be rewarded with additional affinity points that they can either use for themselves or donate back to the non-profit.

The mall may include a philanthropy corridor. Philanthropic organizations doing a variety of charity, ecological and community services work may be rotated into the philanthropy corridor. In this corridor, there may be a “live” volunteer project taking place, allowing anyone with a little spare time to be put to work immediately helping with a task, such as preparing drop-off boxes for a food drive. A wall may separate the philanthropy corridor from other sections of the mall, such as the lounge. The wall may be glass in order to inspire people observing the philanthropy corridor to engage in philanthropy themselves. Activities taking place in the philanthropy corridor may also be streamed to a website to inspire people into action outside the center. The mall may also include a volunteer sign-up booth. A large electronic board over the booth may display the projects and tally up the number of individuals signing up for philanthropic projects.

In addition to the above, the products sold in the center may be color-coded, as described above, based on whether they were manufactured in the US locally, in the U.S. nationally, or in another country. Products may have two green dots for local U.S., one green dot for same state, blue for U.S. national, and yellow for foreign-made products. Products from areas hit by a disaster, to promote a one-for-all-all-for-one vibe, may be modified as described above.

Using the above systems and methods, customers can earn more points for buying locally, fewer points for buying U.S., and even fewer points for buying from abroad. It makes a difference in everyone's life to support their community, and the point allocation model supports this goal. The community will thus be more holistic, have less crime, more brotherhood, more progress and more love over all.

Society is conditioned to respond to discounts and promotional campaigns that reward consumers for choices they make. The yellow blue green model is a promotional way to build business and brand identity and still lay out a comprehensive step-by-step grid toward a better world. Because consumers are being rewarded even for baby steps (small purchases, short volunteer stints, etc.), the model invites members to create a better world we aspire to live in, and it rewards good actions. If a consumer wants to buy a luxury good made in France, that consumer still gets yellow points by buying it locally and the consumer might consider buying blue next time. It is inclusive, not exclusive. A broader message is better to be yellow than nothing at all.

Another alternative aspect may include an online shopping center or web site for green products and other goods the further the program provider's goals. Online shopping on the web site may be run in conjunction with one or more retail centers. The shopping incentives may be the same as, similar to, or different from the shopping incentives offered at the mall or affinity center. Featured vendors and products may be contracted to provide “give back” points to their customers.

Customers may be awarded points according to the color code of the products and services they purchase. Like in-store sales, the geographic location associated with the product's origin for online sales may be the location where the product is made or manufactured or where the product is shipped from (e.g., a warehouse location). For online sales, the purchase location may be the location where the product is to be shipped to (e.g., the customer's home or work address) or the geographic location associated with the IP address from which the purchase was made (e.g., the IP address of the home computer, work computer, or mobile device used to make the purchase). As previously discussed, an amount of affinity points may be assigned to each combination of geographic location associated with the product's origin versus the purchase location. For example, three affinity points may be awarded to the customer if the customer makes an online purchase and the product is shipped from Los Angeles, Calif. to San Francisco, Calif. (i.e., same state). On the other hand, two affinity points may be awarded to the customer if the product is shipped from Los Angeles, Calif. to New York, N.Y. (i.e., same country, but different state). In addition, people may again be able to pool points to make certain things happen in philanthropy or in their communities and countries, with the opportunities both local and national posted on the web site.

The web site may be used to build community as well as trust and name recognition. The web site provides a service by drawing in people who might otherwise not participate in the common good by incentivizing philanthropy. One major incentive to spur philanthropy may be public recognition of those who did the most via daily postings on the web site. Additionally, philanthropists may be recognized at an annual, local and/or national award day that may include an awards concert. As previously discussed, philanthropy may also be incentivized by rewarding philanthropists with affinity points.

Online shopping may be expanded in many ways, including by adding a wider range of products and covering more localities (e.g., different zip codes). A small percentage fee from each sale made on the web site may be collected to sustain the location based affinity program model. Special sponsorship packages may be offered to companies to support charitable campaigns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
comparing, by a computing device, a geographic location of manufacture of an item purchased by a user with a geographic location where the user purchased the item;
determining an amount of affinity points based on the comparison; and
crediting the determined amount of affinity points to a user account stored in an affinity points database system.

2. The method of claim 1, wherein:
the amount of affinity points comprises a first value if the geographic location of manufacture of the item is within a predetermined distance from the geographic location where the user purchased the item, and
the amount of affinity points comprises a second value less than the first value if the geographic location of manufacture of the item is greater than a predetermined distance from the geographic location where the user purchased the item.

3. The method of claim 1, wherein:
the amount of affinity points comprises a first value if the geographic location of manufacture of the item is within the same city as the geographic location where the user purchased the item, and
the amount of affinity points comprises a second value less than the first value if the geographic location of manufacture of the item is not within the same city as the geographic location where the user purchased the item.

4. The method of claim 3, wherein:
the amount of affinity points comprises a third value less than the second value if the geographic location of manufacture of the item is not within the same state as the geographic location where the user purchased the item.

5. The method of claim 4, wherein:
the amount of affinity points comprises a fourth value less than the third value if the geographic location of manufacture of the item is not within the same country as the geographic location where the user purchased the item.

6. The method of claim 1, wherein determining the amount of affinity points comprises:
awarding a first predetermined amount of affinity points if the geographic location of manufacture of the item and the geographic location where the user purchased the item are within the same country;
awarding an additional second predetermined amount of affinity points if the geographic location of manufacture of the item and the geographic location where the user purchased the item are within the same state; and
awarding an additional third predetermined amount of affinity points if the geographic location of manufacture of the item and the geographic location where the user purchased the item are within the same city.

7. The method of claim 1, further comprising:
receiving a request to redeem a reward; and
in response to the request, deducting, from the user account, an amount of affinity points corresponding to the reward.

8. The method of claim 7, wherein the reward comprises at least one of a physical good, a voucher for a service, and an entrance to a restricted facility.

9. The method of claim 1, wherein determining the amount of affinity points based on the comparison comprises:
determining that the purchase of the item qualifies for bonus points; and
in response to determining that the purchase of the item qualifies for bonus points, crediting the bonus points to the user account.

10. The method of claim 9, wherein determining that the purchase of the item qualifies for bonus points comprises determining that a disaster occurred at the geographic location of manufacture of the item.

11. A device comprising:
a processor; and
memory storing computer-executable instructions that, when executed by the processor, cause the device to:
compare a geographic location of manufacture of an item purchased by a user with a geographic location where the user purchased the item;
determine an amount of affinity points based on the comparison; and
credit the determined amount of affinity points to a user account stored in an affinity points database system.

12. The device of claim 11, wherein:
the amount of affinity points comprises a first value if the geographic location of manufacture of the item is within a predetermined distance from the geographic location where the user purchased the item, and
the amount of affinity points comprises a second value less than the first value if the geographic location of manufacture of the item is greater than a predetermined distance from the geographic location where the user purchased the item.

13. The device of claim 11, wherein:
the amount of affinity points comprises a first value if the geographic location of manufacture of the item is within the same city as the geographic location where the user purchased the item, and
the amount of affinity points comprises a second value less than the first value if the geographic location of manufacture of the item is not within the same city as the geographic location where the user purchased the item.

14. The device of claim 13, wherein:
the amount of affinity points comprises a third value less than the second value if the geographic location of manufacture of the item is not within the same state as the geographic location where the user purchased the item.

15. The device of claim 14, wherein:
the amount of affinity points comprises a fourth value less than the third value if the geographic location of manufacture of the item is not within the same country as the geographic location where the user purchased the item.

16. The device of claim 11, wherein the memory stores additional computer-executable instructions that, when executed by the processor, cause the device to:
receive a request to redeem a reward; and
in response to the request, deduct, from the user account, an amount of affinity points corresponding to the reward.

17. The device of claim 16, wherein the reward comprises at least one of a physical good, a voucher for a service, and an entrance to a restricted facility.

18. The device of claim 11, wherein determining the amount of affinity points based on the comparison comprises:
determining that a disaster occurred at the geographic location of manufacture of the item; and
in response to determining that the disaster occurred, crediting bonus points to the user account.

19. A method comprising:
comparing a geographic location of manufacture of an item purchased by a user with a geographic location where the user purchased the item;
determining, by a computing device, whether a type of the purchase made by the user is a foreign purchase, a domestic purchase, an in-state purchase, or a local purchase based on the comparison; and
crediting, to a user account stored in an affinity points database system, an amount of affinity points corresponding to the determined type of purchase.

20. The method of claim 19, wherein:
the amount of affinity points for a domestic purchase is greater than the amount of affinity points for a foreign purchase,
the amount of affinity points for an in-state purchase is greater than the amount of affinity points for a domestic purchase, and
the amount of affinity points for a local purchase is greater than the amount of affinity points for an in-state purchase.
